(19) United States
(12) Patent Application Publication
(10) Pub. No.: US 2026/0187441 A1
(43) Pub. Date: Jul. 2, 2026

(54) LANGUAGE MODEL FOR PREDICTING DIGITAL COMPONENT SELECTION DATA

(71) Applicant: Google LLC, Mountain View, CA (US)

(72) Inventors: Jordan N. Gergov, San Jose, CA (US); Eric Remo Robert Reynolds, Barberino Tavarnelle (IT); Aida Amini, Mountain View, CA (US); Kelvin Gu, Redwood City, CA (US)

(21) Appl. No.: 18/859,059

(22) PCT Filed: Jul. 28, 2023
(86) PCT No.: PCT/US2023/029029

§ 371 Date: Oct. 22, 2024

(51) Int. Cl. G06N 3/08

(52) U.S. Cl. CPC G06N 3/08

(57) ABSTRACT

Methods, systems, and apparatus, including computer programs encoded on a computer storage medium, for training a large language model (LLM) to predict high performing keywords from a set of keywords. The predicted keywords are then used for retrieval processes for digital components.

### BACKGROUND

This specification relates to data processing and, in particular, the use of a language model to predict high performing keywords from a set of keywords.

Digital components, which are discrete units of digital content or digital information, are selected for inclusion with digital content that is served to a requesting user device. To select the digital components to be served, a system needs to be able to evaluate which digital components would be best to serve for a particular serving instance. One way of selecting a digital component is by use of keywords that are associated with the digital component.

However, finding the keywords to associate with a digital component can be challenging. The keywords are typically based on digital content, such as queries that have been received by the serving system. There are often billions of queries to choose from. Moreover, some systems generalize the queries so that the queries can be searched by a provider of the digital components or by a recommendation process that can identify keywords to be associated with the digital components. Other ways of determining keywords can also be used, such as evaluation the content of the digital component itself and determining keywords from the evaluated content.

Moreover, when the keywords are determined, there are typically hundreds, or even thousands, of resulting keywords to choose from. For example, for a single digital component, hundreds of keywords may be generated. To use all of these keywords for a selection of a digital component is inefficient. Processing such a large set of keywords at serving time would waste processing resources, and form the user's perspective, it is impractical to manually maintain the large set of keywords.

### SUMMARY

In general, one innovative aspect of the subject matter described in this specification can be embodied in methods that include the actions of obtaining sets of keywords, each set of keywords used in a selection process for one or more digital components, and each of the keywords having associated performance data that are indicative of a performance of the keyword in the selection process for one or more digital components; for each set of keywords: selecting a proper subset of keywords based on the associated performance data of the keywords, wherein the keywords in the proper subset of keywords exceed the performance of the keywords in set of keywords that are not in the proper subset of the keywords, and removing the keywords in the proper subset of the keywords from the set of keywords to generate a training set of keywords, wherein the training set of keywords is the set of keywords without the removed keywords; training a language model to generate a trained language model, wherein the trained language model predicts, for each training set of keywords, the removed keywords from the training set; processing, by the trained language model, a set of words relating to a target entity to predict a set of keyword recommendations of keywords; and providing, to an acceptance process, the set of keyword recommendations; for each keyword in the set of keyword recommendations that is accepted through the acceptance process, associating the keyword with the target entity for use in the selection process to select one or more digital components for the target entity.

These and other embodiments can each optionally include one or more of the following aspects. In an aspect, the associated performance data that are indicative of a performance of the keyword comprises click data that specifies a click performance metric for each query matched by keywords and a landing page match measure for each query matched by the keyword.

In an aspect, processing, by the trained language model, the set of words relating to a target entity comprises processing, by the trained language model, a set of keywords used in the selection process for one or more digital components relating to the target entity, to predict a set of keyword recommendations of keywords.

In an aspect, the target entity is a web page; and the set of words relating to the target entity are keywords derived from the webpage.

In an aspect, the target entity is a digital component that is served for presentation with a web page; and the set of words relating to the target entity are keywords determined for the digital component.

In an aspect, removing keywords from the proper subset of the keywords to generate a training set of keywords from the set of keywords comprises removing a proper subset of keyword from the proper subset of keywords.

In an aspect, removing keywords from the proper subset of the keywords to generate a training set of keywords from the set of keywords, removing all the keywords from the proper subset of keywords.

Particular embodiments of the subject matter described in this specification can be implemented so as to realize one or more of the following advantages. The techniques discussed in this specification enable the identification of high performing keywords from an input set of keywords. The high performing keywords may be included in the input set, or may be keywords that are not included the input set. This enables the identification of high performing keywords that need not be in the input set, which is an improvement over the prior process of selecting a subset of keywords from an input set. The machine learned model thus implements a task that cannot be practically performed by just selecting a subset of keywords from the input set.

Additionally, by training on actual keyword sets and associated performance data, with the highest performing keywords removed from the training set, the resulting model is less likely to exhibit performance bias based on performance data of the predicted keywords themselves.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a language model predicts keywords for the selecting of digital components.

FIG. 2A is an illustration of a user interface for a keyword selection process.

FIG. 2B is a system flow diagram of the keyword selection process.

FIG. 3A is a system flow diagram of a system for training a language model to predict high performing keywords.

FIG. 3B is a flow diagram of a process for training a language model to predict high performing keywords.

FIG. 4 is a flow diagram of a process for using a language model to predict high performing keywords from an input set of keywords.

FIGS. 5A and 5B are flow diagrams of example processes for determining sets of keywords to use in training a language model.

FIG. 6 a block diagram of an example computer.

Like reference numbers and designations in the various drawings indicate like elements.

### DETAILED DESCRIPTION

The technology described in this written description relates to a large language model (LLM) that is trained to recommend (predict) keywords that provide statistically better performance for digital components (e.g., impressions for advertisements, or clicks for advertisements, etc.), and techniques for using a log-based approach for providing advertisers with “keyword hints” of several keywords that provide a high value return.

Keywords are terms, typically one or more words, such as an n-gram, that are used to match against user queries. The matching may be based on semantic similarity, historical performance, stem matching, and other matching techniques. When a keyword indicates a user query is matched, digital components that are associated with the keyword may be selected for presentation to a user that submitted the keyword.

In an implementation, a system obtains sets keywords. Each of keywords is used in a selection process for one or more digital components. The keywords have associated performance data that are indicative of a performance of the keyword in the selection process. The performance data may be, for example, from logs that store performance data that quantifies the performance of existing sets of keywords that are currently being used to target digital components.

In some implementations, the keywords in each set are selected by determining user queries that are matched by the keywords. Then, for each user query, a performance measure is determined. An example performance measure is a click rate, but other performance measures can also be used. The performance measures of the queries are then used to determine a performance measure for the keyword matched by the queries. In a variation of these implementations, for each user query, a landing page match measure is also determined. The landing page match measure is a measure of how well the user query “matches” a landing page, e.g., is semantically related to the landing page to which the matching queries were used to navigate to the landing page, or is term of which a form (root, synonym, etc.) is found in the landing page, etc. The performance measure for the keyword is then determined based on the performance measures and landing page match measures of each query matched by keyword.

In general, a keyword is more desirable for use in training when a fewer number of queries that have high performance measures match the landing page. This is because some keywords match queries that perform well for a landing page but cannot be derived from the landing page. Because such keywords are very difficult to determine beforehand, this log-based analysis can be used to determine a set of training keywords that meet these criteria for use in training the LLM.

The sets of keywords are used to generate training sets for the LLM. First, for each set of keywords, a proper subset of keywords is selected. The proper subset is based on the associated performance data of the keywords in the set, and the keywords in the proper subset of keywords are the top performing keywords in the set. In other words, the keywords in the proper subset of keywords exceed the performance of the keywords in set of keywords that are not in the proper subset of the keywords.

Then, for each set of keywords, keywords from the proper subset of the keywords are removed to generate a training set of keywords from the set of keywords. The training set of keywords is the set of keywords without the removed keywords. All of the top performing keywords can be removed, or different combinations of top performing keywords can be removed. In the case of the latter, several (or more) training sets can be generated from a single set of keywords.

The LLM is then trained to predict, for each training set of keywords, the removed keywords from the training set. Once the model is sufficiently trained, a set of keywords relating to a target entity is processed to predict a set of keyword recommendations of keywords. The target entity can be, for example, an ad group, and the set of words can be keywords already selected or recommended for the ad group.

Thus, by training the LLM on sets of high-performing keywords, with the subset of the highest performing keywords removed, the LLM can predict, for a set of input keywords, a set of keywords that are very likely to be high performing keywords that meet or exceed the performance of the input keywords. Moreover, because the LLM is trained on keywords that have fewer matching queries that, in turn, match a landing page, the LLM predicts keywords that cannot be readily derived from the landing page. This allows for the LLM to predict keywords that would not otherwise be derived from semantic analysis or other conventional keyword expansion and derivation techniques.

The set of keyword recommendations are then provided to an acceptance process, and for each keyword in the set of keyword recommendations that is accepted through the acceptance process, the keyword is associated with the target entity for use in the selection process to select one or more digital components for the target entity. In some implementations, the target entity is a web page, and the set of keywords relating to the target entity are keywords derived from the webpage. In other implementations, the target entity is a digital component that is served for presentation with a web page, and the set of keywords relating to the target entity are keywords previously determined for the digital component.

These features and additional features are described in more detail below.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

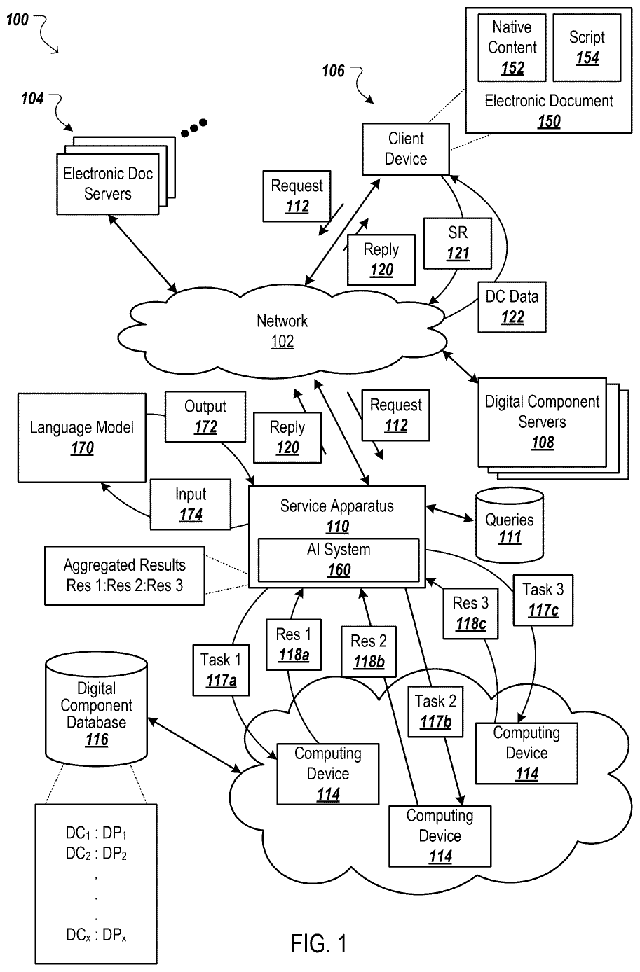

FIG. 1 is a block diagram of an example environment 100 in which a language model predicts keywords for the selectin of digital components. The example environment 100 includes a network 102, such as a local area network (LAN), a wide area network (WAN), the Internet, or a combination thereof. The network 102 connects electronic document servers 104, user devices 106, digital component servers 108, and a service apparatus 110. The example environment 100 may include many different electronic document servers 104, user devices 106, and digital component servers 108.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app, and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords” or simply “keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page. Queries received by users of, for example, a search system, may be stored in a query storage 111.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁−DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlaid over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

Performance of the keywords that result in placement of a digital component can be monitored and stored in logs within the service apparatus 110. For example, data describing click rates, conversion rates, cost per clicks, and other data can be monitored for queries that match keywords associated with a digital component. A particular keyword may have multiple sets of performance data, with each set associated with a particular digital component or group of digital components for which the keyword is used for placement. For example, a first provider of digital components may have selected the keyword “hiking boots” for placement of a first set of digital components, and a second provider of digital components may have selected the keyword “hiking boots” for placement of a second set of digital components. The keyword “hiking boots” will thus have a first set of performance data for the first set of digital components, and a second set of performance data for the second set of digital components.

The service apparatus 110 can also include an artificial intelligence system 160 configured to generate data for the identification of digital components. As described in more detail throughout this specification, the artificial intelligence (“AI”) system 160 can generate digital component selection data (keywords) for digital components. These keywords are then used by providers of digital components as selection criteria for their digital components. A keyword may be a single word or term, or may be a combination of terms and numbers.

A large language model is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code.

An LLM can also be trained for a particular task. In the implementations described in this document, the LLM is trained to predict high performing keywords as output 172 from an input set of keywords 174. A high performing keyword that is predicted may be keywords included in the input set of keywords, or may be a keyword that is not in the input set of keywords.

The language model 170 can be any appropriate language model neural network that receives an input sequence made up of text tokens selected from a vocabulary and auto-regressively generates an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution, e.g., a probability distribution, that assigns a respective score, e.g., a respective probability, to each token in the vocabulary of tokens. The neural network of the language model 170 can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model 170 can be an auto-regressive Transformer-based neural network that includes (i) a plurality of attention blocks that each apply a self-attention operation and (ii) an output subnetwork that processes an output of the last attention block to generate the score distribution.

The language model 170 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020. Such example models include multitask unified model, a zero-shot model, a domain specific model, or a language representation model.

Generally, however, the transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model 170 to generate multiple different candidate output sequences in response to the same request, e.g., by using beam search decoding from score distributions generated by the language model 170, using a Sample-and-Rank decoding strategy, by using different random seeds for the pseudo-random number generator that's used in sampling for different runs through the language model 170 or using another decoding strategy that leverages the auto-regressive nature of the language model.

In some implementations, the language model 170 is pre-trained, i.e., trained on a language modeling task that does not require providing evidence in response to user questions, and the service apparatus 110 (e.g., using AI system 160) causes the language model 170 to generate output sequences according to the pre-determined syntax through natural language prompts in the input sequence.

For example, the service apparatus 110 (e.g., AI system 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

In the implementation described in this specification, the language model 170 is trained to predict high performing keywords from a set of keywords and performance data for the keywords. Once trained, the language model 170 is used to predict keywords that are then used for retrieval processes for digital components.

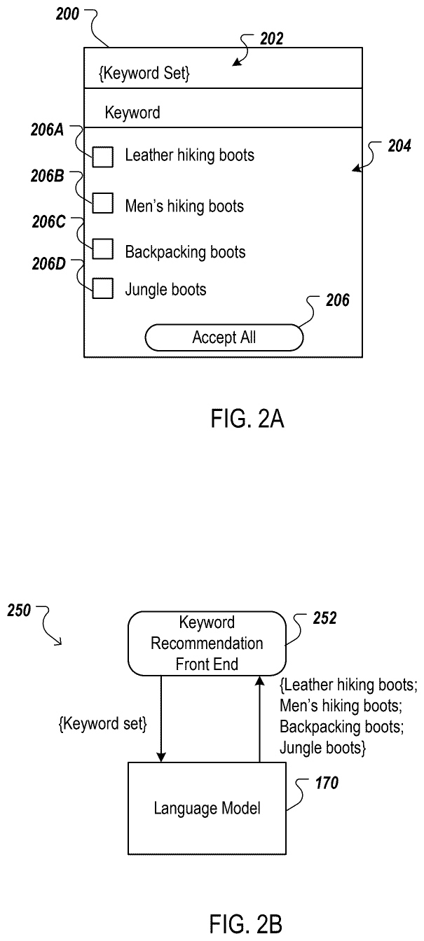

The recommendation and selection of high performing keywords is illustrated with reference to FIGS. 2A and 2B. In particular, FIG. 2A is an illustration of a user interface 200 for a keyword selection process, and FIG. 2B is a system flow diagram 250 of the keyword selection process.

In FIG. 2A, a set of keywords 202, represented by {keyword set}, is provided as input. The set of keywords 202 may be keywords that have been manually curated, or generated by an automated process, or a combination thereof. Typically the keywords are descriptive of the subject matter to which the digital component(s) for which the keywords are being used for selection relate. In FIG. 2A, for example, the set of keywords 202 may relate to hiking boots, and the digital components may be descriptive of the hiking boots, or the provider of the hiking boots.

The user interface 200 may be generated by a keyword recommendation front end 252. The set of keywords 202 is provided to the language model 170. At inference, the language model 170 processes the set of keywords as input, and generates a set of keyword recommendations 204. The set of keyword recommendations 204 are keywords that are predicted to be high performing keywords, where the performance is measured according to one or more performance metric, e.g., a click rate data that specifies a click performance metric for each keyword, or a combination of click rate and conversions, or some other combination for which the model 170 is trained.

As shown in FIG. 2A, the keywords that are predicted to perform very well are leather hiking boots, men's hiking boots, backpacking boots, and jungle boots. A user may select the respective keywords to be used for selection of digital components by clicking the respective selection boxes 204A, 204B, 204C and 204D. Alternatively, the user may select all of the recommended keywords 204 by clicking the Accept All button 206.

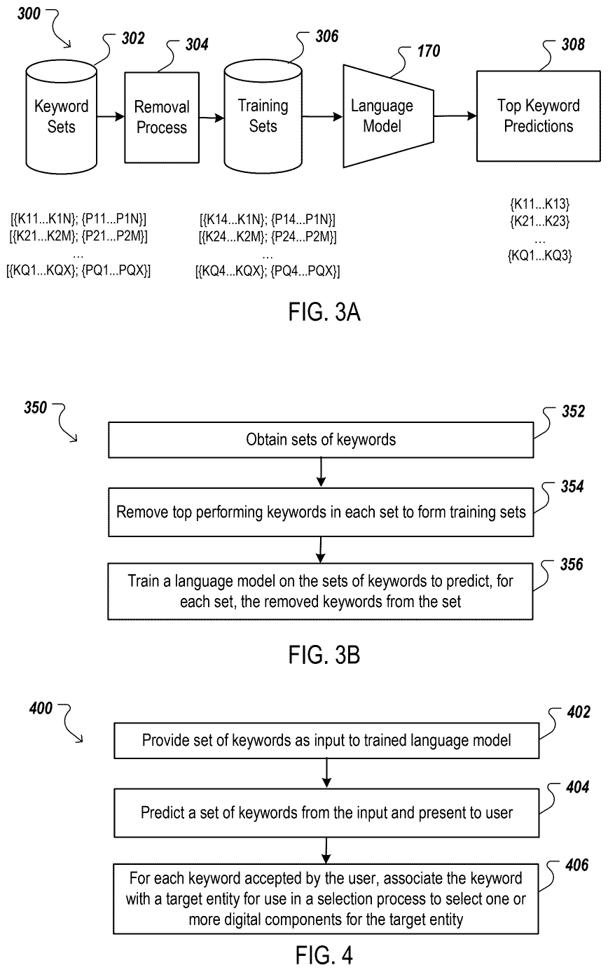

The training of the language model 170 is described with reference to FIGS. 3A and 3B. In particular, FIG. 3A is a system flow diagram 300 of a system for training the language model 170 to predict high performing keywords, and FIG. 3B is a flow diagram of an example process 350 for training a language model to predict high performing keywords. The system 300 and the process 350 may be implemented in a computer system of one or more computers and storage devices in data communication with each other.

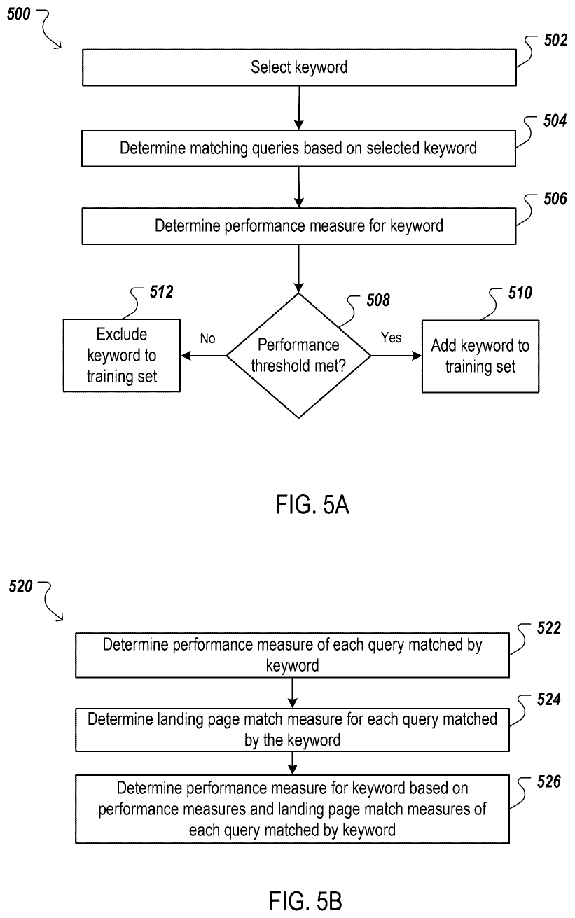

In operation, the process 350 obtains sets of keywords (352). For example, as shown in FIG. 3A, the keyword sets 302 are sets of keywords used in a selection process for one or more digital components. Each of the keywords in a set has associated performance data that are indicative of a performance of the keyword in the selection process for the one or more digital components. As shown in FIG. 3A, there are Q sets keyword training sets of keywords K and associated performance data P for each respective keyword: [{K11 . . . K1N}; {P11 . . . P1N}], [{K21 . . . K2M}; {P21 . . . P2M}], . . . [{KQ1 . . . KQX}; {PQ1 . . . PQX}]. For ease of description, the keywords are indexed by their relative performance as indicated by their performance data, with the index K×1 being the highest performing keyword in each set. Examples of how performance data for keywords are determined is described with reference to FIGS. 5A and 5B.

The process 350 remove top performing keywords in each set to form training sets (354). For example, as shown in FIG. 2A, a removal process 304 removes the top N keywords from each set. For example, for N=3, the resulting training keyword sets are [{K14 . . . K1N}; {P14 . . . P1N}], [{K24 . . . K2M}; {P24 . . . P2M}], . . . [{KQ4 . . . KQX}; PQ4 . . . PQX}].

Although only one training set for each keyword set it shown, multiple training sets for each keyword set may be generated. For example, if N=4, the removal process 304 may remove proper subsets of three of the top four keyword until all combinations are exhausted, e.g., [{K11, K15 . . . KN}, {P11, P15 . . . PN}], [{K12, K15 . . . KN}, {P12, P15 . . . PN}], [{K13, K15 . . . KN}, {P13, P15 . . . PN}][{K14, K15 . . . KN}, {P14, P15 . . . PN}]. Moreover, although the example above describes removing three top performing keywords, fewer or more top performing keywords may be removed to form a training set.

In some implementations, the removal process 304 takes into account the performance data on which the model 170 is to be trained. Then, based on the performance data and for each set of keyword, the removal process 304 selects a proper subset of keywords based on the associated performance data of the keywords. The keywords in the proper subset of keywords are the top performing keywords in the set, i.e., keywords that exceed the performance of the other keywords in set of keywords that are not in the proper subset of the keywords. The removal process 304 then removes the keywords in the proper subset of the keywords from the set of keywords to generate a training set of keywords. The training set of keywords is the set of keywords without the removed keywords.

The process 350 then trains the model 170 on the sets of keywords to predict, for each set, the removed keywords from the set (356). During training, the model 170 is provided the keyword training sets as input, and generates predicted high performing keywords. The training processes adjusts model weights and parameters based on the difference between the predicted high performing keywords for an input set of training keywords and the removed keywords from the training set. The difference can be determined by a loss function the processes the embeddings of the predicted keywords, the removed keywords, predicted performance, and, optionally, the input keywords. This process is repeated until the model 170 achieves a performance level that is deemed to be satisfactory. Any appropriate training process that achieves the training described above can be used.

After the model 170 is trained, it is persisted and is made available for use.

FIG. 4 is a flow diagram of a process 400 for using a language model to predict high performing keywords from an input set of keywords. The process 400 may be implemented in a computer system of one or more computers and storage devices in data communication with each other.

The process 400 provides a set of keywords as input to trained language model (402). For example, as described with reference to FIGS. 2A and 2B, a set of keywords 202 may be provided as input.

The process 400 predicts a set of keywords from the input and presents the keywords to the user (404). For example, as described with reference to FIGS. 2A and 2B, a set of high performing keywords 204 are predicted, and sent to a user device for display.

The process 400, for each keyword accepted by the user, associates the keyword with a target entity for use in a selection process to select one or more digital components for the target entity (404). For example, the target entity may be a group of digital components, e.g., advertisements, that are then associated with one or more of the predicted keywords. The keywords are then used to provide the digital components in response to queries or for placement on web pages.

FIGS. 5A and 5B are flow diagrams of example processes for determining sets of keywords to use in training a language model. The process 500 may be implemented in a computer system of one or more computers and storage devices in data communication with each other.

The process 500 is used to select, from a set of keywords that are used to target digital components, keywords that are to be included in a training set of keywords for training a language model.

The process 500 selects a keyword (502). Each keyword that is selected may be a keyword that is already associated with one or more digital components.

The process 500 determines matching queries that match the keyword based on the selected keyword (502). A matching query may be based on a semantic similarity process, historical performance, a stem matching process, and other matching techniques.

The process 500 determines a performance measure for the keyword (502). The performance measure is based on performance of the mating queries. The performance may be click rate based, conversion based, impression based, or some other performance base. The performance can be an average of the performance values of the keywords, or some other central tendency or statistic.

The process 500 determines whether the performance measure meets a performance threshold (508). The performance threshold may be a reference value that is selected by a system administrator, or may be a tuned reference value.

If the process 500 determines the performance measure meets the performance threshold, then the process 500 adds the keyword to the training set (510). For example, the keyword may be added to one of the sets 302 of FIG. 3A.

Conversely, if he process 500 determines the performance measure does not meet the performance threshold, then the process 500 does not add the keyword to the training set, then the process 500 (510).

In some implementations, they keywords in the training sets 302 are keywords that meet a threshold performance measure from matching queries that are not predominately determined from a landing page or other digital component associated with the keyword. This enables the language model to train on keywords that are not directly derived from content of the landing page or digital component. One such process for choosing such keywords in the process 520 of FIG. 5B. The process 520 may be implemented in a computer system of one or more computers and storage devices in data communication with each other.

The process 520 determines a performance measure of each query matched by keyword (522). The performance may be click rate based, conversion based, impression based, or some other performance base. The performance measure may be stored in a log of the apparatus 110, or determined from the serving and interaction data stored in the log.

The process 520 determines a landing page match measure for each query matched by the keyword (524). The landing page match measure is a measure of how well the user query “matches” a landing page, e.g., is semantically related to the landing page to which the matching queries were used to navigate to the landing page, or is term of which a form (root, synonym, etc.) is found in the landing page, etc.

The process 520 determines the performance measure for the keyword based on performance measures and landing page match measures of each query matched by the keyword (526). In some implementations, the performance measure of a keyword is proportional to the performance measures of the matching queries and inversely proportional landing page matching measure of each query matched by keyword, e.g., P_{KWD}=f(P({Q})/f(LPM({Q}), where f(*) is a function that generates a performance measure or landing page match measure based on the constituent performance measures and landing page match measures of the matching queries {Q}.

In other implementations, the landing page match measure may be a binary value, where each query is determined to “match” or “not match” a landing page. Queries that are determined to match have a value of 0, and queries that are determined to match have a value of 1. A minimum number of queries N that are not matched to a landing page, e.g., N=10, may be required before a keyword is evaluated for inclusion in a training set. If the keyword is evaluated, then the performance measure is based on the performance measures of the non-matching queries.

Other ways of determining performance measures for keywords can also be used.

In general, a keyword is more desirable for use in training when a fewer number of queries that have high performance measures match the landing page. This is because some keywords match queries that perform well for a landing page but cannot be derived from the landing page. Because such keywords are very difficult to determine beforehand, the log-based analysis can be used to determine a set of training keywords that meet these criteria for use in training the LLM.

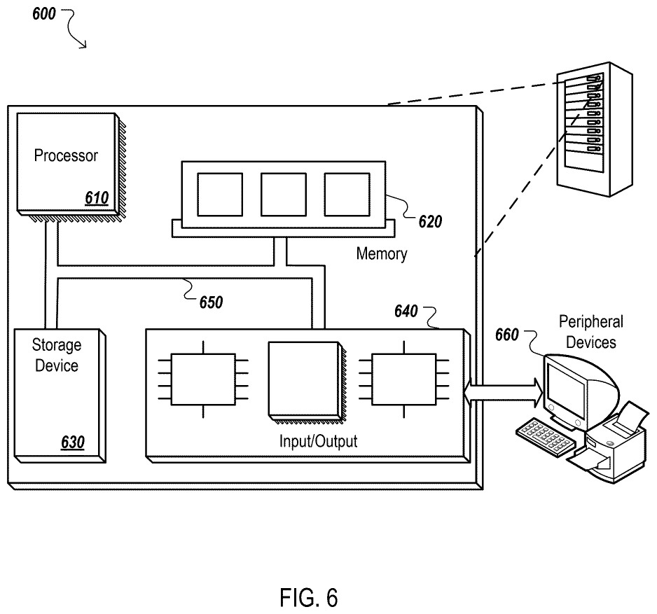

FIG. 6 is a block diagram of an example computer system 600 that can be used to perform operations described above. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 600. In one implementation, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 660. Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described.

Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
obtaining sets of keywords, each set of keywords used in a selection process for one or more digital components, and each of the keywords having associated performance data that are indicative of a performance of the keyword in the selection process for one or more digital components;
for each set of keywords:
selecting a proper subset of keywords based on the associated performance data of the keywords, wherein the keywords in the proper subset of keywords exceed the performance of the keywords in set of keywords that are not in the proper subset of the keywords; and
removing the keywords in the proper subset of the keywords from the set of keywords to generate a training set of keywords, wherein the training set of keywords is the set of keywords without the removed keywords;
training a language model to generate a trained language model, wherein the trained language model predicts, for each training set of keywords, the removed keywords from the training set;
processing, by the trained language model, a set of words relating to a target entity to predict a set of keyword recommendations of keywords;
providing, to an acceptance process, the set of keyword recommendations; and
for each keyword in the set of keyword recommendations that is accepted through the acceptance process, associating the keyword with the target entity for use in the selection process to select one or more digital components for the target entity.

2. The computer-implemented method of claim 1, wherein the associated performance data that are indicative of a performance of the keyword comprises click data that specifies a click performance metric for each query matched by keyword and a landing page match measure for each query matched by the keyword.

3. The computer-implemented method of claim 2, wherein the performance of a keyword is proportional to the performance measures of the matching queries that match the keyword and inversely proportional to landing page match measures of the matching queries that match the keyword.

4. The computer-implemented method of claim 1, wherein processing, by the trained language model, the set of words relating to a target entity comprises processing, by the trained language model, a set of keywords used in the selection process for one or more digital components relating to the target entity, to predict a set of keyword recommendations of keywords.

5. The computer-implemented method of claim 4, wherein:
the target entity is a web page; and
the set of words relating to the target entity are keywords derived from the webpage.

6. The computer-implemented method of claim 5, wherein:
the target entity is a digital component that is served for presentation with a web page; and
the set of words relating to the target entity are keywords determined for the digital component.

7. The computer-implemented method of claim 1, wherein removing keywords from the proper subset of the keywords to generate a training set of keywords from the set of keywords:
removing a proper subset of keyword from the proper subset of keywords.

8. The computer-implemented method of claim 1, wherein removing keywords from the proper subset of the keywords to generate a training set of keywords from the set of keywords:
removing all the keywords from the proper subset of keywords.

9. The computer-implemented method of claim 1, wherein the language model is one of a multitask unified model, zero-shot model, domain specific model, or a language representation model.

10. A system, comprising:
one or more computers in data communication; and
one or more non-transitory computer readable medium storing instructions executable by the one or more computers that when executed by the one or more computers cause the one or more computers to perform operations comprising:
obtaining sets of keywords, each set of keywords used in a selection process for one or more digital components, and each of the keywords having associated performance data that are indicative of a performance of the keyword in the selection process for one or more digital components;
for each set of keywords:
selecting a proper subset of keywords based on the associated performance data of the keywords, wherein the keywords in the proper subset of keywords exceed the performance of the keywords in set of keywords that are not in the proper subset of the keywords; and
removing the keywords in the proper subset of the keywords from the set of keywords to generate a training set of keywords, wherein the training set of keywords is the set of keywords without the removed keywords;
training a language model to generate a trained language model, wherein the trained language model predicts, for each training set of keywords, the removed keywords from the training set;
processing, by the trained language model, a set of words relating to a target entity to predict a set of keyword recommendations of keywords;
providing, to an acceptance process, the set of keyword recommendations; and
for each keyword in the set of keyword recommendations that is accepted through the acceptance process, associating the keyword with the target entity for use in the selection process to select one or more digital components for the target entity.

11. The system of claim 10, wherein the associated performance data that are indicative of a performance of the keyword comprises click data that specifies a click performance metric for each query matched by keyword and a landing page match measure for each query matched by the keyword.

12. The system of claim 11, wherein the performance of a keyword is proportional to the performance measures of the matching queries that match the keyword and inversely proportional to landing page match measures of the matching queries that match the keyword.

13. The system of claim 10, wherein processing, by the trained language model, the set of words relating to a target entity comprises processing, by the trained language model, a set of keywords used in the selection process for one or more digital components relating to the target entity, to predict a set of keyword recommendations of keywords.

14. The system of claim 13, wherein:
the target entity is a web page; and
the set of words relating to the target entity are keywords derived from the webpage.

15. The system of claim 13, wherein:
the target entity is a digital component that is served for presentation with a web page; and
the set of words relating to the target entity are keywords determined for the digital component.

16. The system of claim 10, wherein removing keywords from the proper subset of the keywords to generate a training set of keywords from the set of keywords:
removing a proper subset of keyword from the proper subset of keywords.

17. The system of claim 10, wherein removing keywords from the proper subset of the keywords to generate a training set of keywords from the set of keywords:
removing all the keywords from the proper subset of keywords.

18. One or more non-transitory computer readable medium storing instructions, that when executed by an artificial intelligence system, causes the artificial intelligence system to perform operations comprising:
obtaining sets of keywords, each set of keywords used in a selection process for one or more digital components, and each of the keywords having associated performance data that are indicative of a performance of the keyword in the selection process for one or more digital components;
for each set of keywords:
selecting a proper subset of keywords based on the associated performance data of the keywords, wherein the keywords in the proper subset of keywords exceed the performance of the keywords in set of keywords that are not in the proper subset of the keywords; and
removing the keywords in the proper subset of the keywords from the set of keywords to generate a training set of keywords, wherein the training set of keywords is the set of keywords without the removed keywords;
training a language model to generate a trained language model, wherein the trained language model predicts, for each training set of keywords, the removed keywords from the training set;
processing, by the trained language model, a set of words relating to a target entity to predict a set of keyword recommendations of keywords;
providing, to an acceptance process, the set of keyword recommendations; and
for each keyword in the set of keyword recommendations that is accepted through the acceptance process, associating the keyword with the target entity for use in the selection process to select one or more digital components for the target entity.

19. The non-transitory computer readable medium of claim 18, wherein the associated performance data that are indicative of a performance of the keyword comprises click data that specifies a click performance metric for each query matched by keyword and a landing page match measure for each query matched by the keyword.

20. The non-transitory computer readable medium of claim 18, wherein the performance of a keyword is proportional to the performance measures of the matching queries that match the keyword and inversely proportional to landing page match measures of the matching queries that match the keyword.
